(19) United States
(12) Patent Application Publication
(10) Pub. No.: US 2020/0005632 A1
(43) Pub. Date: Jan. 2, 2020

(54) TRAFFIC LIGHT ADAPTIVE LEARNING AND MAPPING METHOD AND SYSTEM FOR IMPROVING VEHICLE ENERGY EFFICIENCY AND DRIVING COMFORT

(71) Applicant: Intelligent Commute LLC, Novi, MI (US)

(72) Inventors: Xuefei Chen, Novi, MI (US); Zhibin Tan, Troy, MI (US)

(21) Appl. No.: 16/433,577

(22) Filed: Jun. 6, 2019

Related U.S. Application Data
(60) Provisional application No. 62/681,754, filed on Jun. 7, 2018.

(51) Int. Cl. G08G 1/01; G08G 1/052; H04W 4/44; G06K 9/00; G08G 1/056

(52) U.S. Cl. CPC G08G 1/0112; G08G 1/052; G08G 1/0129; G06K 9/00825; G08G 1/056; H04W 4/44

(57) ABSTRACT

A traffic light signal timing learning system and related method include a camera configured on a vehicle to obtain a traffic light signal when approaching a traffic light; a global positioning system (GPS) sensor to simultaneously obtain GPS location of said vehicle; and a control module to record the traffic light signal, time information and GPS location. The learned information is stored in a table in the control module and in a cloud server as a traffic light map, which in turn can be used for optimizing vehicle speed or optimizing the utilization of the power from different vehicular power sources, which consequently improves the vehicle's energy efficiency as well as driving comfort.

The present patent application claims priority of U.S. patent application No. 62/681,754 filed on Jun. 7, 2018 that is incorporated by reference herein.

### BACKGROUND

Existing driving maps do not provide traffic light timing information. Traffic light mapping research includes using a vehicular communication system (V2X). V2X is a technology which incorporates vehicle to infrastructure (V2I), vehicle to vehicle (V2V), and vehicle to grid (V2G). V2X may use a dedicated short-range communication (DSRC) or LTE-V (e.g., 4G or 5G) technology for communications. V2X has not been widely implemented or deployed, and may require: 1) vehicles using V2V to depend on each other, which means other vehicles may have to install compatible DSRC or LTE-V models; and 2) infrastructure may have to install corresponding transceiver modules in order to enable traffic information communications. For example, traffic lights may have to have a transmitter or transceiver module to send traffic light information to receiving vehicles. Thus, the cost of V2X may be high.

### SUMMARY

An exemplary embodiment method for traffic light signal timing learning includes: obtaining a traffic light signal by a camera configured on a vehicle while said vehicle is approaching a traffic light; simultaneously obtaining a global positioning system (GPS) location of said vehicle by a GPS sensor; and recording the traffic light signal, a time information and said GPS location.

The method may include sending the recorded traffic light signal, time information and GPS location to a server to create a traffic light signal timing map. The method may include creating a traffic light signal timing table with the recorded traffic light signal, time information and GPS location in a control module of said vehicle; and exchanging said traffic light signal timing table between said vehicle and a server to create a traffic light signal timing map.

The method may include determining the light to record according to a preset route when the vehicle is approaching a multiple lights location. The method may include retrieving simultaneously a traffic light signal value from said traffic light signal timing map according the time and the GPS location while obtaining a traffic light signal by said camera; and comparing the retrieved signal value and the obtained signal to confirm or update said traffic light signal timing map.

An exemplary embodiment traffic light signal timing learning system includes a camera equipped on a vehicle to obtain a traffic light signal while said vehicle is approaching a traffic light; a global positioning system (GPS) sensor to obtain simultaneously GPS location of said vehicle; and a control module to record the traffic light signal, time information and said GPS location.

The system may include a server to communicate with said control module to exchange the recorded traffic light signal, time information and GPS location to create a traffic light signal timing map. The system may be applied wherein the control module is configured for creating a traffic light signal timing table. The system may include a server to communicate with said control module to exchange said traffic light signal timing table to create a traffic light signal timing map.

### BRIEF DESCRIPTION OF THE DRAWINGS

FIG. 1 is a block diagram of a traffic light learning system;

FIG. 2 is a block diagram of a traffic light learning process method; and

FIG. 3 is a block diagram of a traffic light information look up method.

### DETAILED DESCRIPTION

The present disclosure provides a system and method utilizing onboard sensors (camera, GPS, etc.) to detect traffic lights and recognize light status, as well as to record light position and vehicle driving direction. The system then stores and updates an onboard or cloud-side traffic light status timing table from daily driving. After a number of update iterations, a stable traffic light timing table is recorded for frequent driving routes. This works for fixed-timing traffic lights. Once vehicular systems have the traffic light information, they are able to optimize power utilization from different power sources and optimize their speeds, such as to either pass the traffic light without a stop or prepare for an early stop. As a result, vehicles are able to conserve energy and improve driving comfort. These concepts may be referred to herein as ECO-approach and/or ECO-departure.

Exemplary embodiment systems and methods are provided for traffic light signal timing learning based upon an onboard vehicular camera or smart device camera for ECO-approach to a traffic light and ECO-departure from a traffic light, which may improve driving comfort, as well as optimizing the power utilization from different power sources for hybrid vehicles, which may improve vehicular fuel economy. The system includes an onboard camera and a control module with GPS sensor, as well as an onboard computing device or a cloud server. The camera installed on a vehicle captures the traffic light image and detects the traffic light as well as traffic light signal status (red, green, etc.), while the control module records the traffic light status information with position, direction, and time information.

The information is adaptively updated every time the vehicle passes the same traffic light. This learning process does not require the vehicle to pass the light in the same direction every time, because the traffic light signals in different directions at a single intersection are well correlated. Eventually, for each traffic light, a close to actual traffic light timing table will be achieved. This table will be stored in the local controller and optionally on a cloud server so that the information can be shared with other vehicles or for more comprehensive data analysis at a cloud site. For instance, the cloud server can also simulate the traffic volume in real-time based on vehicle speed, vehicle stops, the time taken for the vehicle to drive from one intersection to another, or the like. With such information, as well as the traffic light information, the cloud server can generate a more detailed traffic map and provide optimal routes for users. The users here are not only vehicle controllers, but also drivers. The map can be provided by an application used by a smart phone, tablet or pad to display the traffic information, which includes the traffic light information.

After the traffic light information table is generated, vehicles are able to optimize the power utilization from different power sources, and optimize their speeds, so that vehicles can, for example, either prepare to pass what will be a green traffic light without stopping, or prepare to stop early or re-route for what will be a red traffic light. As a result, vehicles are not only able to save the energy but also improve the driving comfort.

For example, a vehicular system may include a camera, a location system, and a control module. The control module may have access to information about the intended path/route of the vehicle, the current speed limit, upcoming speed limit changes, traffic/congestion conditions along the route, the current speed of the vehicle, and other conditions of the vehicle and the upcoming path. Route information may comprise information about an entire planned trip (i.e. a route provided by a mapping system on the vehicle or connected device) and/or information about immediate plans (i.e. a turn signal or lack thereof). The camera and the location system may collect information about the status of upcoming traffic lights and the position of the vehicle, respectively, and may pass this information to the control module. The control module may determine when the upcoming traffic light will change status (i.e. from green to red) and may use that information in conjunction with information about traffic congestion around the traffic light to determine whether or not the vehicle can pass the traffic light before it changes status while not traveling over the speed limit. If the vehicle is able to pass the traffic light, the control system may determine that the vehicle should accelerate to the speed limit. If the vehicle is not able to pass the traffic light, the control system may determine that the vehicle should decelerate to a stop ahead of the traffic light. In some embodiments, the control system may present this information to a human operator through a visual interface or other output. Visual output may comprise, for example, an indicator on the vehicle dashboard or on a smartphone mounted in the vehicle. Such output may indicate whether the driver should speed up or slow down, or may indicate a speed at which the driver should drive the vehicle. In some embodiments, the control system may use this information to directly control the speed of the vehicle. If the vehicle draws power from multiple sources, the control system may control the source from which power is drawn based on a current speed of the vehicle or an anticipated speed of the vehicle. In some embodiments, the control system may determine a preferred alternate route for the vehicle based on the status of an upcoming traffic light and a present location of the vehicle.

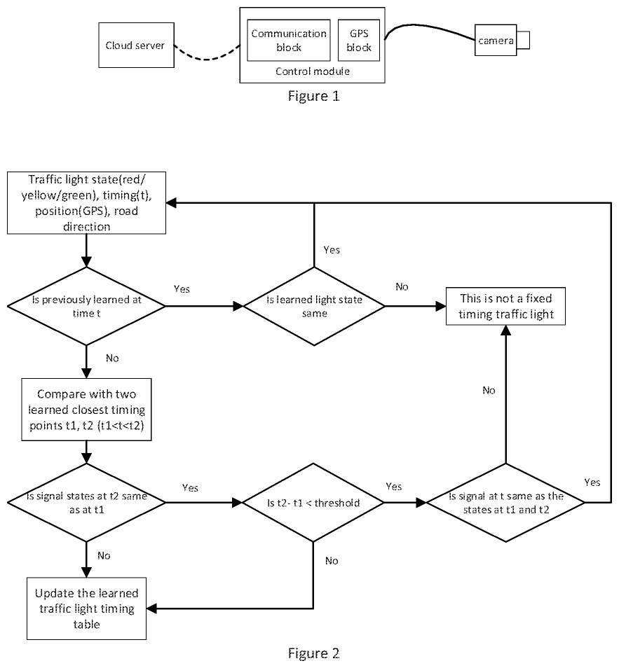

As shown in FIG. 1, an exemplary embodiment system includes at least one camera, at least one global positioning system (GPS) sensor, and at least one control module. The control module may be equipped with a communications unit or chip, and the system may include at least one cloud server. The GPS sensor can either be part of the control module or be an independent sensor. One skilled in the art will recognize that any type of location sensor may be used in place of or in addition to a GPS sensor. The communications unit is intended for uploading the detected traffic light information to the cloud server. The controller extracts the traffic light information from the images captured by the camera, then stores the information in the control module and may also upload to the server. During driving, before the next traffic light down the road is detected, the controller estimates the light state by looking up the traffic light table, and provides the estimated information to vehicle controller.

The camera is used to detect the traffic lights, and capture the traffic light states, such as red, yellow or green solid or arrow, steady or flashing. The camera can be installed behind the windshield or other places with a line of sight to traffic lights.

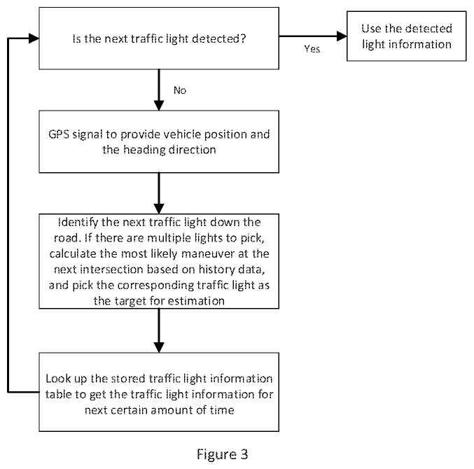

Turning to FIGS. 2 and 3, the control module processes the image, detects traffic lights in the scene and identifies the states of the detected traffic lights. Also, with the help of GPS and lane detection or map information, the control module can identify the right (e.g., in lane) traffic light in the cases of multiple lights existing at an intersection, for example. Then, the controller stores the light status together with the timing, the position, and driving direction information. In driving, before the next traffic light down the road is detected, the controller identifies the next expected traffic light first based upon the GPS information and vehicle driving direction. Based on the time, the controller looks up the traffic light information table, which could be either in the controller or from the cloud server, to get the expected state of that traffic light. This information will then be provided to vehicle controller for vehicle control optimization.

If the traffic light has a displayable timer, the controller will directly detect and record the traffic light timing information, so that the controller immediately knows the switching time of the light.

If the traffic light does not have a displayable timer, the controller will learn the traffic light timing information by the following learning process, also as shown in FIG. 2:
a. When a vehicle passes a traffic light, the aforementioned controller will capture the state of the traffic light, timing, position, and driving direction.
b. If the traffic light has been previously recorded for this point of time, and the light states are the same, then, the process indicates that the learned timing value is validated as true.
c. If this light has been previously recorded for this point of time, and the light states are different, that means this traffic light might have a varying timing schedule.
d. If the traffic light has not been previously recorded at this point of time, t, the controller will find two time-wise closest learned points, t1 and t2, where t1<t<t2.
e. If the traffic light states at t1 and t2 are different, then, store the current traffic light information into learned table.
f. If the traffic light states at t1 and t2 are the same, and t2−t1>threshold, controller also updates the traffic timing table. Note that the threshold refers to the duration of the traffic light for each state.
g. If the traffic light states at t1 and t2 are the same, and t2−t1<=threshold, and if the light status at t is same as t1 and t2, that means the learned timing value is validated as true.
h. If the traffic light states at t1 and t2 are the same, and t2−t1<=threshold, and if the light status at t is different from t1 and t2, that means this traffic light might not have fixed timing schedule.

The traffic light timing may vary due to other factors, such as temporary traffic control by police. Therefore, the traffic timing information will not be decided by a one-time learning process. The system will keep updating its learning table. And the latest learned value always has higher weighting. Therefore, for a single vehicle, after the vehicle passes the same traffic light a sufficient number of times, the controller will approximately know the actual traffic light switching times.

The learned value need not only be stored in the control module on the vehicle, but also may be sent to the cloud server, so that the information can be shared with other vehicles equipped with the same system or can be combined with information from other vehicles and analyzed within the cloud server to gather more comprehensive traffic light timing information. This information may then be transferred to vehicles through an over the air (OTA) update process.

It can be expected that when there are enough vehicles using this system, this traffic light learning process will be completed faster, and the accuracy will be higher.

The light information may be integrated into an interactive map. If the driver types the destination into the map and lets the map generate the route, the controller presented in this invention will immediately know which traffic lights to look up in the stored traffic light information table.

If the above-mentioned map is not provided, the system works as follows and also shown in FIG. 3:

a. When a vehicle heads to the next intersection and before the vehicle detects the traffic light, the control module identifies the correct traffic light first by looking up the light information table based on the GPS information and the vehicle heading direction.

b. If the coming intersection has multiple lights, such as for example, where there is an individual right turn light, left turn light, or the like, the controller will calculate the possibilities of the heading directions based on previous maneuvers. The previous maneuvers can be extracted from the GPS history data. The maneuver associated with the highest possibility will be taken as driver's intention and subsequently the corresponding traffic light will be picked as the target light. This works for a driver doing a daily commute, for example.

c. Once which traffic light is decided, based on the time, the controller searches in the traffic light table to get the state and the timing information of that traffic light for the following time until the light is detected by the camera.

d. As soon as the traffic light is detected in real time, the controller will stop using the estimated information, and use the real time detected information instead. The switch from estimated value to the detected value can be a linear transition or a non-linear transition, which in turn may help improve the accuracy of the detection.

The estimated or the real-time light information will then be provided to the vehicle controller for application. Once a vehicle controller knows the traffic light information of the traffic lights down the road, it can:
1) Optimize the vehicle speed, pass the traffic lights without stopping, or preparing to stop earlier. For instance, it may tip out of the accelerator pedal to save power output or regenerate more braking energy.
2) Optimize the power utilization from different power sources, so that the whole powertrain system runs most efficiently over a period of time for a hybrid electric vehicle.
3) The optimization may be based on the next one or series of traffic lights. For example, it is likely that a vehicle may not be able to get to each intersection with traffic light in green considering the real traffic conditions. However, the controller may provide a solution so that the vehicle can meet the least number of red lights.
4) The optimization can also take the real traffic information into consideration. For instance, with the real traffic information provided by the cloud server and the empirical driving information, the system can calculate an optimal route. The system can provide an optimal vehicle speed profile, based on which the vehicle can optimize its power utilization from different power sources with the knowledge of future power requirements.

As a result, vehicles can realize improved energy consumption and driving comfort. Another feature of this system is that the traffic light information sent to the cloud server can be integrated into a map, which may be provided with the traffic information to other users, which not only means vehicles, but also includes drivers.

What us claimed is:

1. A method for traffic light signal timing learning, the method comprising:
obtaining a traffic light signal with a camera disposed on a vehicle while said vehicle is approaching a traffic light;
obtaining simultaneously a global positioning system (GPS) location of said vehicle with a GPS sensor; and
recording the traffic light signal, simultaneous time information and GPS location.

2. The method of claim 1, further comprising creating a traffic light signal timing map based on the recorded traffic light signal, time information and GPS location.

3. The method of claim 2, further comprising optimizing power utilization from different vehicular power sources and vehicle speed based on the traffic light signal timing map.

4. The method of claim 2, further comprising sending the recorded traffic light signal, time information and GPS location to a server to create the traffic light signal timing map.

5. The method of claim 1, further comprising creating a traffic light signal timing table with the recorded traffic light signal, time information and GPS location.

6. The method of claim 5 wherein the traffic light signal timing table is created in a control module of said vehicle.

7. The method of claim 5, further comprising exchanging said traffic light signal timing table between said vehicle and a server to create a traffic light signal timing map.

8. The method of claim 1, further comprising determining the light to record according to a preset route when the vehicle is approaching a multiple light location.

9. The method of claim 2, further comprising:
retrieving simultaneously a traffic light signal value from said traffic light signal timing map according the time and the GPS location while obtaining a traffic light signal by said camera; and
comparing the retrieved signal value and the obtained signal to confirm or update said traffic light signal timing map.

10. The method of claim 5, further comprising optimizing power utilization from different vehicular power sources and vehicle speed based on the traffic light signal timing table.

11. A traffic light signal timing learning system, comprising:
a camera configured on a vehicle to obtain a traffic light signal while said vehicle is approaching a traffic light;
a global positioning system (GPS) sensor to simultaneously obtain GPS location of said vehicle;
a control module to record the traffic light signal, simultaneous time information and GPS location.

12. The system of claim 11, further comprising a server to communicate with said control module to exchange the recorded traffic light signal, time information and GPS location to create a traffic light signal timing map.

13. The system of claim 12, wherein the control module is configured to optimize power utilization from different vehicular power sources and vehicle speed based on the traffic light signal timing map.

14. The system of claim 12, wherein the control module is configured for creating a traffic light signal timing table.

15. The system of claim 14, wherein the control module is configured to optimize power utilization from different vehicular power sources and vehicle speed based on the traffic light signal timing table.

16. The system of claim 11, further comprising a server to communicate with said control module to exchange said traffic light signal timing table to create a traffic light signal timing map.

17. The system of claim 16, wherein the control module is configured to optimize power utilization from different vehicular power sources and vehicle speed based on the traffic light signal timing map.

18. A method of traffic light signal timing learning for a vehicle, the method comprising:
obtaining a traffic light signal from a traffic light while the vehicle is approaching the traffic light;
recording the traffic light signal and a time at which the traffic light signal is obtained;
obtaining a location of the vehicle; and
recording the location and a time at which the location is obtained.

19. The method of claim 18, wherein the traffic light signal and the location are obtained simultaneously.

20. The method of claim 18, further comprising:
obtaining a vehicle driving direction; and
recording the vehicle driving direction and a time at which the vehicle driving direction is obtained.
